(19) United States
(12) Patent Application Publication
(10) Pub. No.: US 2010/0314044 A1
(43) Pub. Date: Dec. 16, 2010

(54) APPARATUS & METHOD FOR MAKING AN AIR FILTER

(76) Inventor: Al Morris, Shakespeare (CA)

Correspondence Address: HONEYWELL/CANTOR COLBURN;Patent Services, 101 Columbia Road, P.O. Box, Morristown, NJ, 07962-2245, US

(21) Appl. No.: 12/482,600

(22) Filed: Jun. 11, 2009

(51) Int. Cl. B29C 65/40; B29C 65/00; B65B 51/00

(52) U.S. Cl. 156/290; 156/60; 156/331.7; 156/293

(57) ABSTRACT

A method of making a filter by thermoforming a plurality of individual packages each of the plurality of packages having a first portion hingably attached to a second portion and placing a media portion in each of the plurality of packages and dispensing a curable product in each of the plurality of individual packages and curing the curable product such that a portion of the media is now fixedly secured to the curable product.

### TECHNICAL FIELD

Exemplary embodiments of the present invention are directed to an apparatus and method for manufacturing an air filter.

### BACKGROUND

Current air filters are made with filtration media that has a polyurethane seal that is molded about the media in reusable tooling. Once the media is molded to the polyurethane the filter is then removed from the tooling and placed into predetermined packaging. The molds for such a process are expensive and thus tooling for new models of air filters is expensive. The packaging for the molded filter is also expensive from a procurement stand point and from a disposal aspect. In addition, a labor intensive process is then used to place the molded filter into packaging for shipment to a retail store. Moreover, the box board and/or corrugated materials used for the filter packaging are bulky and can be expensive for consumers to handle and recycle.

Accordingly, it is desirable to provide a method and apparatus for producing packaging and handling costs for the manufacture and sale of air filters.

### SUMMARY

In one exemplary embodiment, a method of making a filter by thermoforming a plurality of individual packages each of the plurality of packages having a first portion hingably attached to a second portion and placing a media portion in each of the plurality of packages and dispensing a curable product in each of the plurality of individual packages and curing the curable product such that a portion of the media is now fixedly secured to the curable product.

In another exemplary embodiment, a method for making a filter is disclosed, the method including the steps of thermoforming a plurality of individual packages each having a first portion hingably attached to a second portion; advancing each of the individual packages towards a media dispensing apparatus; placing a media portion formed by the media dispensing apparatus into the first portion of each of the plurality of packages; advancing each of the individual packages towards a curable liquid dispensing apparatus; dispensing a curable liquid in the second portion of each of the plurality of packages by the curable liquid dispensing apparatus; moving the first portion towards the second portion such that a portion of the media portion is now in the curable liquid; and curing the curable liquid such that a portion of the media is fixedly secured to the curable liquid.

The above described and other features are exemplified by the following figures and detailed description.

### DRAWINGS

Referring now to the figures, which are exemplary embodiments, and wherein like elements are numbered alike:

FIG. 1 is a schematic illustration of a method and apparatus for making a filter in accordance various embodiments of the present invention; and

FIG. 1A is an enlarged section of FIG. 1.

### DETAILED DESCRIPTION

In one exemplary embodiment a continuous flow process is utilized for thermoforming a clam shell plastic package wherein the clam shell package performs the dual function of both packaging and tooling for the air filter.

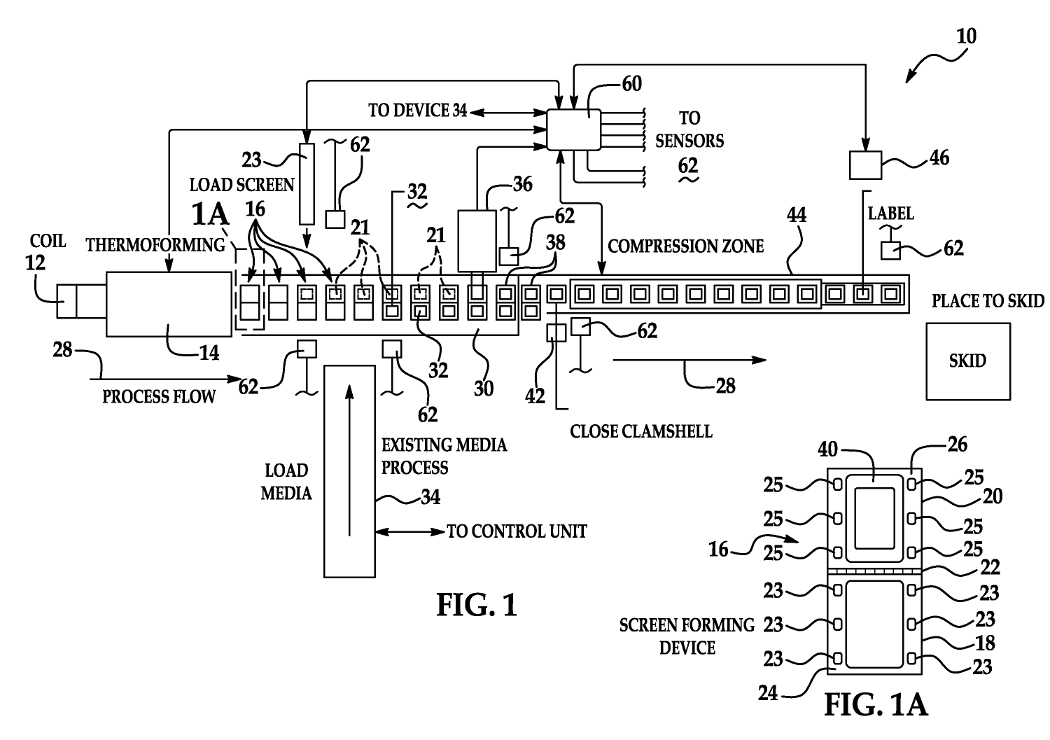

Referring now to FIG. 1 a schematic illustration of an apparatus/method of forming a filter in accordance with an exemplary embodiment of the present invention is illustrated by reference numeral 10. One exemplary embodiment is directed to an apparatus and/or method for forming and packaging an air filter. In one embodiment, the air filter is a panel air filter. Of course, other types of fluid filters are contemplated and other non-panel configurations are contemplated to be within the scope of exemplary embodiments of the present invention.

Here a coil of plastic material 12 is provided such that a sheet of plastic material can be continuously fed into a thermoforming device 14. The thermoforming device 14 uses a thermoforming process that creates a plurality of individual packages 16. Thermoforming is a manufacturing process where a plastic sheet is heated to a pliable temperature and formed to a specific part shape in a mold by applying a vacuum, and shaped item is then trimmed to create a final product. Each individual package 16 has an upper portion or first portion 18 and a lower or second portion 20. The upper portion is movably attached to the lower portion by a hinge portion 22. In one embodiment, plastic material 12 is a transparent or see-through material so that the contents held with the package are viewable to a consumer at a retail store. In one non-limiting embodiment, a peripheral edge 24 of the first portion is configured to have a plurality of features 23 for engaging complimentary features 25 of a peripheral edge 26 of the second portion. In this embodiment, the features of the peripheral edges will engage each other and help to secure the first portion to the second portion when the first portion is folded on top of the second portion.

After each of the plurality of individual packages 16 are formed using the thermoforming device they are advanced in the direction of arrow 28 by for example, a conveyor belt 30 or any other equivalent device wherein the packages are placed on the moving conveyor. As the packages advance from the thermoforming device filter media 32 formed in accordance with known technologies is provided by a media forming device 34 (illustrated schematically in FIG. 1). Here preformed or preconfigured filter media is provided by device 34, which may be any one of a plurality of machines for pleating media together or a device for simply supplying preformed media to the packages.

In one non-limiting exemplary embodiment, the filter media comprises non-woven materials pleated or secured to each other to form the filter media in accordance with known technologies. Non-limiting examples of non-woven media include but are not limited to synthetic and cellulose based non-woven medias. Of course, other materials are contemplated for the filter media.

Here the device 34 will provide media to each one of the packages wherein the media is disposed in upper portion 18. In one embodiment, the movement of conveyor 30 will be controlled by a sensor that determines when media is disposed in upper portion 18 and then the package advances onto the next step in the process. The packages and the conveyor are positioned such that first portion 18 is positioned to receive media 32 as it is provided by media forming device 34.

Also located in each of the lower or second portion 20 is a screen or support member 21 that provides rigidity to the filter formed by exemplary embodiments of the present invention. The screen will be configured to have a plurality of openings such that fluid may flow through the filter however, the screen will provide rigidity to the formed filter. In order to provide the screen or support member to the package a screen cutting/forming device 23 is provided to place precut screens in second portion 20. Here screen or support members 21 are provided by a cutting, stamping or any other equivalent process wherein correctly sized screens are placed in second portion 20. Non-limiting examples of materials for screen or support member 21 are metals, alloys, plastics, and equivalents thereof. As with the media dispersement a sensor may be provided to detect the presence of a screen in package 16 for controlling movement of the conveyor 30 as well as screen dispensing device 23. In addition, the placement of screen or support member 21 in second portion 20 may occur before or after placement of the media in first portion 18 as long as it occurs before application of the curable liquid as will be discussed below. Alternatively and as applications permit filters may be made without screen or support member 21.

Thereafter and as each package is provided with media and a support member (detected by a sensor) a dispensing device 36 is positioned to dispense a curable product or curable liquid such as polyurethane 38 or equivalents thereof into a cavity or mold 40 formed in second portion 20 of the package. Once the polyurethane is dispensed in the mold again a sensor may be employed to control the dispersement and movement of the conveyor or a signal may be generated from device 36 every time it dispenses polyurethane or any other curable material, the first portion of the package is folded over onto the second portion such that media 32 is now located in the second portion such that a peripheral edge of the media and the screen is disposed in the uncured polyurethane in order to form the filter (e.g., the edges of the media and the screen (if applicable) are covered by the polyurethane while a face portion of the media is uncovered with the polyurethane on opposite facing sides to provide a filter. At this step in the process, a plunger or other type of device 42 is positioned to fold the first portion over onto the second portion. Now the screen and filter media and the curable polyurethane or other equivalent material is encased within a package defined by the first portion and the second portion. One non-limiting example of device 42 may be a pneumatic plunger that folds the upper section or first portion onto the lower section or second portion.

Once the first portion is folded onto the second portion and in some embodiments the peripheral edges of the portions engage each other the folded package is now provided to a compression device 44 such that a constant force is applied to the package as the polyurethane cures about the screen and filter media and the package advances in the direction of arrow 28. The time of applying a compression force will, of course, correspond to the time needed to cure the polyurethane. For example, some urethanes only need 2-3 minutes of compression while the overall curing time is 6-7 minutes. Of course, these time periods may vary accordingly to be greater or less than the aforementioned values.

Once the package leaves the compression device the exterior of the package can be applied with labeling via any suitable device 46 capable of placing indicia on the package. Non-limiting examples of indicia include, Trademarks, brand names, sku numbers, advertising, etc., this indicia may be applied via labels, printing processes or any suitable application process. In another alternative, the indicia is pre-printed on the plastic material 12 prior to its formation by device 14. In another embodiment, the labeling is used to secure the first portion to the second portion. In still another embodiment, an adhesive or heat staking or welding process is used to secure the first portion to the second portion. Of course, the labeling process may occur during any suitable time of this process for example, prior to the thermoforming process. After the labeling process the package is ready for shipping to a distribution center or is further packaged with other packages in a larger container for shipment. Alternatively, groups of packages may be banded together for shipping.

Once formed, the filter is shipped to a distribution system still in the same package (package 16) that was used for forming the filter. The package would be transparent to allow for manufacturing inspection and customer visibility of the product they are purchasing. Marketing graphics could be displayed by placing labels on the exterior of the package in discrete locations. Other types of contemplated packages include biodegradable plastics or plastic materials suitable for recycling thus providing a green product.

The cost of making new filter models will be significantly reduced as the only change required for the new filter design will be to the thermoforming tool and if necessary, a means for supplying media and a screen of a different configuration for the newly provided tool. In addition, the cost to manufacture the end product would also be significantly reduced as much of the assembly labor is used in the packaging of the product. Furthermore, the cost of waste handling of the distribution system will be reduced as the package that the filter is manufactured in is the same package in which the end-user receives the product. Accordingly, overall packaging costs would also be reduced. This could be marketed as an environmental improvement by reducing packaging while delivering an appealing product to consumers.

Accordingly, the product is manufactured in the same package that the consumer receives it in. One exemplary embodiment of the present invention may be viewed as a method of forming a filter having the following non-limiting process steps: 1) the plastic is purchased in a coiled sheet form and fed into thermoforming equipment; 2) The sheet is formed into a package having the shape of the filter; 3) a filter screen (if necessary) is formed and inserted into one half of the package the side the polyurethane will be disposed in; 4) the filter media is formed and inserted into one half of a clamshell package formed by the thermoforming device or one portion of the package that does not have a mold for polyurethane to be dispersed therein; 5) liquid polyurethane is poured or dispensed into the half of the clamshell or package that does not have the media located therein but has the screen therein; 6) the clamshell or package is closed and placed into a compression system which provides compression on the closed package until polyurethane has fully expanded and cured about the media and the screen in the package; 7) an exterior portion of the clamshell package is then labeled and coded (in an alternative the material of the package is already pre-printed prior to forming); and 7) The clamshell with the filter and is placed onto a skid for shipment to a distribution system. Of course, the aforementioned steps are only provided as one example and the sequential description of the steps is intended to limit exemplary embodiments of the present invention to the specific order described above.

In one embodiment, a control unit 60 comprising a microprocessor or other equivalent device is coupled to each of the devices 14, 23, 34, 36, 42, 44 and 46 and a plurality of sensors 62 each of which is configured to detect the presence of any one of the package, the screen or support member, the media in the package, the curable product or polyurethane in the package and to provide signals to any one of the thermoforming device, screen forming device, media forming device, polyurethane dispensing device, the plunger, compression device, conveyor belts, the conveyor and the labeling device in order to anyone of the aforementioned devices in order to control the overall process of making the air filter.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for making a filter, comprising:
thermoforming a plurality of individual packages, each of the plurality of packages having a first portion hingably attached to a second portion;
placing a media portion in the first portion of the plurality of packages;
dispensing a curable product in the second portion;
manipulating the first portion towards the second portion such that a portion of the media portion is disposed in the curable product of the second portion and the media portion and the curable product are encased by the first portion and the second portion; and
curing the curable product such that a portion of the media is fixedly secured to the curable product.

2. The method as in claim 1, further comprising compressing the first portion towards the second portion in order force the media portion into the curable product.

3. The method as in claim 1, further comprising applying a label to an exterior surface of each of the plurality of individual packages.

4. The method as in claim 1, wherein the filter is an air filter and the curable product is liquid polyurethane.

5. The method as in claim 4, wherein the air filter is a panel filter and the curable product is a seal disposed about a periphery of the panel filter.

6. The method as in claim 1, wherein each of the plurality of individual packages are formed from a translucent material.

7. The method as in claim 1, wherein each of the plurality of individual packages are formed from a biodegrable plastic.

8. The method as in claim 1, wherein a peripheral portion of the first portion of each of the plurality of individual packages has a first plurality of features for engaging a second plurality of features disposed on a peripheral portion of the second portion of each of the plurality of individual packages.

9. The method as in claim 1, wherein the second portion of each of the plurality of individual packages has a cavity for receiving the curable product therein and the first portion of each of the plurality of individual packages has a receiving area configured to receive the media portion therein, the receiving area being configured such that a portion of the media is disposed in the cavity of the first portion when the first portion is manipulated towards the second portion.

10. The method as in claim 1, wherein each of the plurality of individual packages is the packaging the filter is sold in at a retail outlet.

11. A method for making a filter, comprising:
thermoforming a plurality of individual packages, each of the plurality of packages having a first portion hingably attached to a second portion;
advancing each of the individual packages towards a media dispensing apparatus and a screen dispensing apparatus;
placing a screen member formed by the screen dispensing apparatus in a second portion of each of the plurality of packages;
placing a media portion formed by the media dispensing apparatus in the first portion of each of the plurality of packages;
advancing each of the individual packages towards a curable liquid dispensing apparatus;
dispensing a curable liquid in the second portion by the curable liquid dispensing apparatus;
moving the first portion towards the second portion such that a portion of the media portion and a portion of the screen member is disposed in the curable liquid of the second portion and the media portion, the screen member and the curable liquid are encased by the first portion and the second portion; and
curing the curable liquid such that the portion of the media and the portion of the screen member is fixedly secured to the curable liquid.

12. The method as in claim 11, further comprising compressing the first portion towards the second portion in order force the media portion and the screen portion into the curable liquid.

13. The method as in claim 11, further comprising applying a label to an exterior surface of each of the plurality of individual packages, wherein the label is pre-printed on a material used for the packages prior to the thermoforming step.

14. An air filter formed by the method of claim 11, wherein the curable liquid is polyurethane.

15. The method as in claim 14, wherein the air filter is a panel filter and the polyurethane defines a seal extending from and disposed about a periphery of the panel filter.

16. The method as in claim 11, wherein each of the plurality of individual packages are formed from a translucent material formed from a biodegrable plastic.

17. The method as in claim 11, wherein a peripheral portion of the first portion of each of the plurality of individual packages has a first plurality of features for engaging a second plurality of features disposed on a peripheral portion of the second portion of each of the plurality of individual packages.

18. The method as in claim 11, wherein the second portion of each of the plurality of individual packages has a cavity for receiving the curable liquid therein and the first portion of each of the plurality of individual packages has a receiving area configured to receive the media portion therein, the receiving area being configured such that the portion of the media and the portion of the screen is disposed in the cavity of the first portion when the first portion is manipulated towards the second portion.

19. The method as in claim 11, wherein each of the plurality of individual packages are advanced towards the media dispensing apparatus and the curable liquid dispensing apparatus by a conveyor belt.

20. The method as in claim 19, wherein the media dispensing apparatus and the curable liquid dispensing apparatus are operated by a sensor positioned to detect the presence of one of the plurality of individual packages.
